(19) United States
(12) Patent Application Publication
(10) Pub. No.: US 2012/0324005 A1
(43) Pub. Date: Dec. 20, 2012

(54) DYNAMIC AVATAR PROVISIONING

(76) Inventor: Gargi Nalawade, San Jose, CA (US)

(21) Appl. No.: 13/482,951

(22) Filed: May 29, 2012

Related U.S. Application Data
(60) Provisional application No. 61/490,616, filed on May 27, 2011.
(60) Provisional application No. 61/494,223, filed on Jun. 7, 2011.
(60) Provisional application No. 61/496,126, filed on Jun. 13, 2011.
(60) Provisional application No. 61/497,418, filed on Jun. 15, 2011.
(60) Provisional application No. 61/505,680, filed on Jul. 8, 2011.
(60) Provisional application No. 61/533,268, filed on Sep. 12, 2011.
(60) Provisional application No. 61/619,877, filed on Apr. 3, 2012.

(51) Int. Cl. G06F 15/16

(52) U.S. Cl. 709/204

(57) ABSTRACT

Various systems and methods incorporating techniques described in this paper relate to online social networks and other online social services. Some systems and methods enable a user to create and associate two or more avatars with their online user profile on social-based web resource (e.g., social networking web site), and provide/provision the avatars for use with the online user profiles according to those associations. Some systems and methods facilitate and manage dynamic grouping of users. Some systems and methods permit dynamic grouping of user and user connections on a social-based web resource, and can determine the nature of those connections. Some systems and methods implement a mechanism for a user to be automatically notified of upcoming conferences or conventions in advance of their registrations deadlines. Some systems and methods permit a targeted group of people within a certain group to be reached by a single message.

### CROSS-REFERENCE TO RELATED APPLICATIONS

This application claims priority to U.S. Provisional Application Ser. Nos. 61/490,616 filed Can 27, 2011, entitled “Targeted Group Messaging;” 61/494,223 filed Jun. 7, 2011, entitled “Dynamic, Self—Organizing User Groups;” 61/496,126 filed Jun. 13, 2011, entitled “Intelligent, Dynamic Conference Clustering;” 61/497,418 filed Jun. 15, 2011, entitled “Dynamic, Self—Organizing User Groups;” and 61/505,680 filed Jul. 8, 2011, entitled “Connections View Engine;” 61/619,877 filed Apr. 3, 2012, entitled “Avatars, Intents and Universes;” each of which is incorporated by reference.

### BACKGROUND

Online social networks, such as Facebook®, LinkedIn® or Google+®, and other online social services, such as Twitter®, Reddit®, Digg®, Pinterest®, have become prevalent form of communication and socializing over the Internet. A social network generally provides each user with an online user profile, through which the user can communicate and socialize with other users on the same social network or on a different social network. Effectively, a user's online profile of a given social network represents the user's presence on the given social network. Each social network typically provides a user with only one online profile accessible to other users of the social network and, at times, to non-users as well. Access to an online user profile can include view-only access to the profile or view and post access to the profile. Unfortunately, social-based online services, such as online social networks and online social services, suffer from several drawbacks.

The real life of individual users is very different from the limitations social networks and social tools adhere to, particularly with respect to multiple facets of a user's personalities. Certain users can wish to exhibit a given facet of their life based on certain situations and can wish to show certain facets to only specific individuals. The avatar associated with a user's online profile is one way by which facets of their life are exhibited. However, typical online user profiles are associated with only one avatar, thereby limiting the number of facets a user can exhibit through their avatar in association with their online profile.

With respect to online user groups and online social groups, membership/subscription to such groups is largely manual and static. Traditionally, individual users have to manually search for groups to join (e.g., based on their current interests). Additionally, subscribing to and unsubscribing from a group is usually a manual process, and selecting groups to join can be hit or miss with respect to group activity level. A group with a lot of members might be dead because members have moved on to other interests and are no longer interested in the group or that the group's interest.

With regard to connections, today's online social networks or social tools are one big blob into which connections melt away and lose transparency as well as clarity on the nature of the connection. If someone wanted to see all the connections that live in a particular city, share a particular interest, or work in a particular sector/technology, he or she must manually search through the connections.

As a general matter, online social networks and tools are underleveraged with respect to promoting and marketing conferences and conventions. Today, the most common way to find out and register for a conference or a convention is through word of mouth or email promotions/marketing sent by conference/convention organizers. In few instances, a social network or tool user can learn of a conference or convention through friends, referrals or their employers. Presently, there is no method by which for a social network or tool user can automatically identify what kind of conferences, conventions, or conference/convention sessions he or she would like to attend, or what speakers he or she would like to hear (e.g., in order to advance their career). Often, users either miss conferences that would have been of interest or learns of them when it is too late (e.g., after they have missed the early bird registration deadline).

The foregoing example of desirable areas of research and development that are lacking in the state of the art are intended to be illustrative and not exclusive.

### SUMMARY

Various systems and methods incorporating techniques described in this paper relate to online social networks and other online social services (hereafter known collectively as “social-based web resources”).

Some systems and methods enable a user to create and associate two or more avatars with their online user profile on social-based web resource (e.g., social networking web site), and provide/provision the avatars for use with the online user profiles according to those associations. The associations between avatars and a user's online profile can be according to certain aspects of the user, also referred to hereafter as user dimensions (e.g., user's interests, geography, skills, activities, user feeds, online social service posts, or intents). For some implementations, different aspects of a user's online profile (e.g., user dimensions presented in the user's online profile) can be associated with different avatars and used (e.g., presented) in the context of those associations. For instance, a given online user profile can express three different interests (e.g., a baseball team, a musical artist, and a college alma mater), and each of those interests can have a different avatar associated with those interests such that when the that online user profile is presented in the context of one of those interests, the resulting presentation will include the corresponding avatar. Hence, when a fellow user views the online user profile through the context of sports (e.g., the fellow user and user of the online profile have common interest in the same baseball team), the user's avatar that has been associated with the baseball will be presented in association with the user's online profile. The context in which a given online user profile is presented can be differ according to the user viewing it and can also differ according to the method of access (e.g., online profile is being view through a forum relating to sports). In various implementations, the set of avatars utilized with online user profiles on different web resources (e.g., different social networking sites) can be consistent with the others or can differ for a given user dimension (e.g., avatar used in association with a sports team on one social-based web resource will differ from the avatar used in association the same sports team on another social-based web resource). For some implementations, a given online user profile can be associated with single dimensions and, as such, can have only a single avatar associated with it at a given moment.

Some such systems and methods can provide a user with the freedom to express the many different sides of their personality by way of the avatars. Each of the avatars utilized can be reflect a different facet of the user's life. For some implementations, each aspect of a user's online profile (e.g., different social groups, different events, different interests, different connections) can be associated a different avatar; in doing so, when other users (e.g., friends and guests) access (e.g., view) a particular aspect of a user's online profile, that aspect is represented by the associated avatar. A user can, for example, create one or more avatars based on the different hats he or she wears. For instance, a user can have an avatar to represent their role as a product manager (which can be their day job), an avatar to represent their role as an entrepreneur (which can be the user's evening job), an avatar to represent their role as a volunteer (which is what the user can do as a side passion or hobby), and an avatar to represent their role as a football coach (which the user can do on the weekends).

Accordingly, various implementations can permit a user to create multiple avatars and then select one or more avatars to project, for example, to a particular group, or in association with a particular event. Some implementations can permit the user to activate two or more avatars for use on any particular social networking site. Additionally, certain implementations can associate each avatar with one or more user intents that the particular avatar is expected to derive. Examples of user intents include job hunting, networking, finding teachers, selling goods, buying goods, dating, and traveling.

Some systems and methods facilitate and manage dynamic grouping of users. The dynamic group of users can be, for example, according to the users' interests or associations (e.g., with other users, or other user groups). Management of the dynamic group can include automatically subscribing users to a dynamic group and unsubscribing users from a dynamic group based, for instance, changes with regard to a user (e.g., a user's interest or association). For some implementations, a user's interest can currently relate to a specific area, topic, activity, interest, or discussion. For various implementations, users are chosen and clustered based on one or more user dimensions, such as a user's interests, geography, skills, activities, user feeds, or online social service posts (e.g., social network posts).

Some systems and methods permit dynamic grouping of users or user connections on a social-based web resource, and figure the nature of those users or connections, without the need for manually reviewing the users or user connections and explicit searching. In certain implementations, dynamic grouping according to connection can be based on a dimension of a user, including a user's geographic location or interests in a specific subject areas, topics, activities, or discussions. In some implementations, dynamic groups based on users or user connections are generated by clustering users according to dimensions they currently have in common. Various implementations update the dynamic grouping of users or user connections at or near real-time. Hence, for some implementations, as a user's connections (e.g., in association with their online user profile) change, so does the dynamic grouping of such the user or the user connections.

Some systems and methods implement a mechanism for a user to be automatically notified of upcoming conferences or conventions in advance of their registrations deadlines. Various implementations utilize information clustering, according to user dimensions aggregated from social-based web resources, to identify users who can have particular interest in an upcoming conference or convention. Based on the potential interest, various implementations can inform a user of an upcoming conference or convention. Some implementation can also perform analysis of a user's experience level and skill sets, during the clustering process, to gauge a given user's level of interest.

Some systems and methods permit a targeted group of people within a certain group to be reached by a single message. Various implementations can be configured to reach send a targeted group message (TGM) to a targeted group of people, where the targeted group of individuals can be identified according to clustering and/or analysis of user dimensions.

### BRIEF DESCRIPTION OF THE DRAWINGS

FIG. 1 depicts an example of a dynamic social avatar provisioning system in use in an exemplary environment, in accordance with various implementations.

FIG. 2 depicts an example of a dynamic social avatar provisioning system in accordance with various implementations.

FIG. 3 depicts a flowchart of an example of a method for dynamically provisioning social avatar in accordance with various implementations.

FIG. 4 depicts a flowchart illustrating an example of correlations/associations between avatars, social universes, and user dimensions, in accordance with various implementations.

FIG. 5 depicts an example of a dynamic clustering system, in use in an exemplary environment, in accordance with various implementations.

FIG. 6 depicts an example of a dynamic clustering system in accordance with various implementations.

FIG. 7 depicts a conceptual diagram an example of dynamic clustering system for user grouping in accordance with various implementations.

FIG. 8 depicts a flowchart of an example of a method for dynamically clustering in accordance with various implementations.

FIG. 9 depicts a flowchart illustrating an example of a dynamic clustering system for conference/convention notifications in accordance with various implementations

FIG. 10 depicts a flowchart of an example of a method for conference/convention notifications in accordance with various implementations.

FIG. 11 depicts a flowchart of an example of a method for target group messaging in accordance with various implementations.

FIG. 12 depicts an example of a computer system on which techniques described in this paper can be implemented.

### DETAILED DESCRIPTION

Specific implementations of the invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. For the purpose of clarity, technical material that is known in the technical fields related to the invention has not been described in detail so that the invention is not unnecessarily obscured.

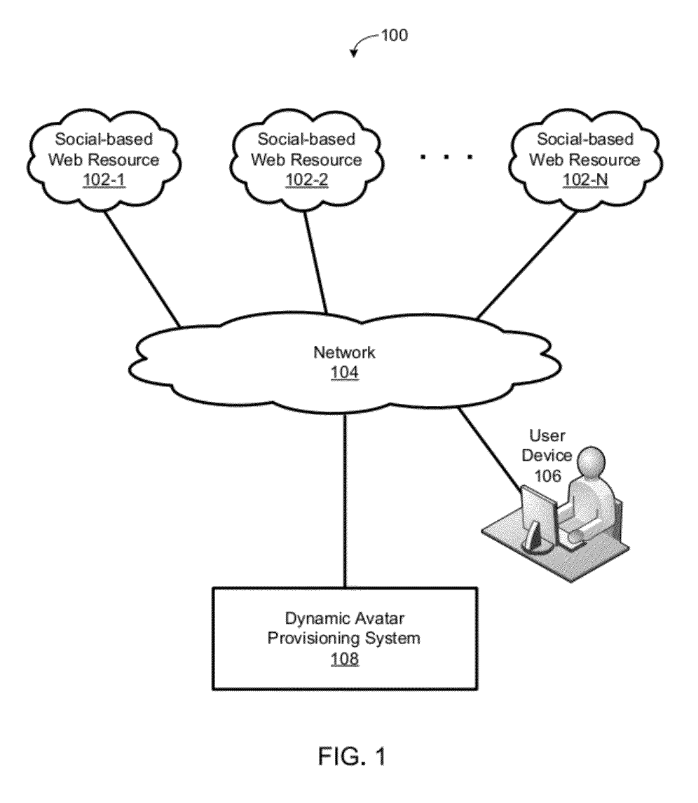

FIG. 1 depicts an example of a dynamic social avatar provisioning system 108 in use in an exemplary environment 100, in accordance with various implementations. In the example of FIG. 1, the exemplary environment 100 includes a network 104, one or more social-based web resources 102-1 to 102-N (hereafter referred to collectively as the social-based web resources 102), a user device 106, and the dynamic social avatar provisioning system 108.

In the example of FIG. 1, the network 104 is intended to include an applicable communications network such as the Internet, a public switched telephone network (PSTN), an infrastructure network (e.g., private LAN), or some other network that is capable of acting as a link between the various components depicted in FIG. 1. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). A PSTN can include wired or wireless (e.g., 4G/3G/2G) network operated by, for example, a central provider. An infrastructure network that offers wireless connectivity can include wired and wireless devices in communication with wireless access points (WAPs).

In the example of FIG. 1, the social-based web sources 102 are coupled to the network 104. The social-based web sources 102 can include known or convenient social networks, such as Facebook®, Linkedln® or Google+®, and other online social services (e.g., social news and social media postings), such as Twitter®, Reddit®, Digg®, Pinterest®. The social-based web sources 102 can comprise social structures operative to connect individuals, persons, or entities, by levels of interdependency. Thus, any or all of the social-based web sources 102 can connect members based on friendship, familial relationships, financial relationships, business relationships, ideological relationships or other relationships (e.g., interests or intents).

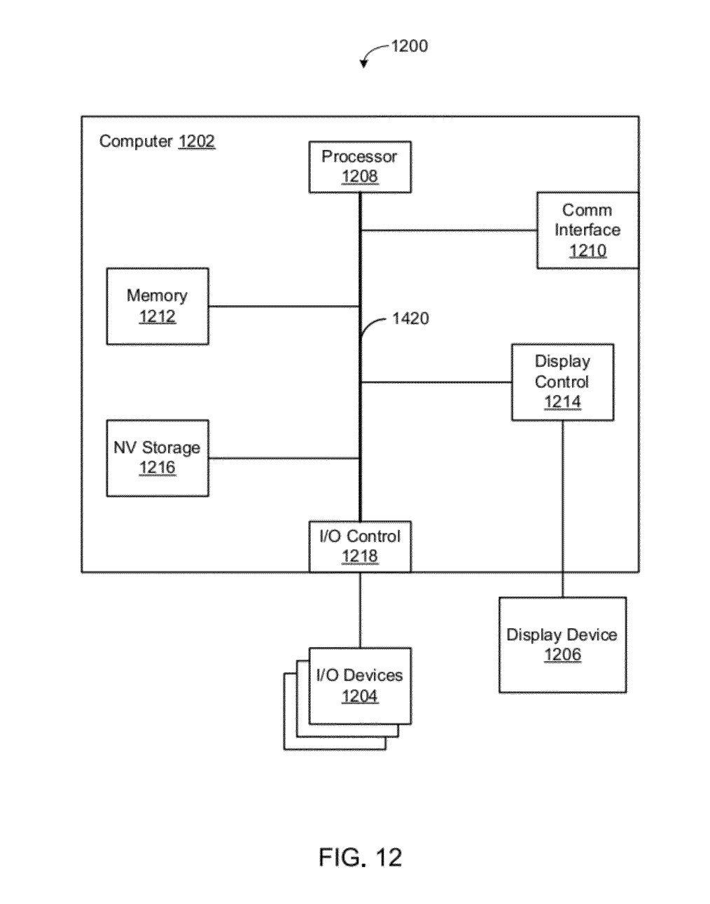

In the example of FIG. 1, the user device 106 is coupled to the network 104. The network 104 can include a local network and an intermediate network, where the user device 106 can be coupled to the intermediate network 102 through a local wireless network. At a minimum, a user device 106 can include a processor, memory (though the memory could be implemented in the processor), a radio, and a radio interface (though the radio interface could be implemented as “part of” the radio). In order to make the user device 106 will typically have at least one input device and at least one output device, including input and output interfaces, if applicable. A user device can include components of a computer system 1200, as shown in FIG. 12.

In the example of FIG. 1, the user device 106 can be as a phone, personal data assistant (PDA), computing device, laptop, net book, tablet, camera, music/media player, GPS device, networked appliance, or some other known or convenient user device; and/or various types of intermediate networking devices. The user device 106 can or cannot be a wireless device, but the description often refers to the user device as a wireless device because it is a likely implementation in at least a subset of user cases. Through the user device 106, a user can access one or more of the social-based web resources 102 (e.g., social network or social news) and search for other users, user postings, communicate with other users, and make connections with other users. Additionally, the user can search for other users having common dimensions (e.g., interests, activities, hobbies, and discussion).

In the example of FIG. 1, the dynamic social avatar provisioning system 108 can include a dynamic avatar engine, an avatar datastore, a user investigation engine, and a social-base web resource interface engine. A dynamic avatar engine can be configured to manage a set of avatars for a user, manage association between avatars in the set and the user's various online profiles on the social-based web resources 102, and provision avatars for use with the user's various online profiles according to aspects of the user's online profile (e.g., according to the user dimensions included in the user's online profile). The avatar datastore can be configured to store the set of avatars managed and provisioned, and can include the association between the avatars and online user profiles. The user investigation engine can configured to access and gather information regarding a given user from the social-based web resources 102. The social-based web resource interface engine can configured to provide access to the social-based web resources 102 and, as such, can be utilized by the user investigation engine to access the social-based web resources 102 and by the dynamic avatar engine to provision (e.g., provide) an avatar to one or more of the social-based web resources 102 for use with an online user profile (e.g., in connection with a particular user dimension included in the online user profile).

As used herein, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but can or cannot be limited to hardware.

A datastore, as used herein, can be implemented as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

Implementations of the dynamic avatar provisioning system 200 can enable an individual user of a social-based web resource, such as a social networking site, to use more than one avatar in connection with a given online user profile, where each avatar can reflect (e.g., is mapped for use with) one or more different facets of the user's life that are included in the given online user profile. Effectively, the dynamic avatar provisioning system 200 can permit a user to have multiple avatars associated for use with specific groups, interests, intents, events, or colleagues in connection with their online user profile. In some implementations, a user can create one or more avatars based on the different hats he or she wears (e.g., roles the user fills). For instance, a user can have an avatar that is used in association with the user's role as a product manager which could be their day job, another avatar that is used in association with the user's role as an entrepreneur (which could be the user's evening job), another avatar that is used in association with the user's role as a volunteer (which is what the user does as a side passion or hobby), and yet another avatar that is used in association with the user's role as a football coach (which the user does on the weekends). With respect to more personal facets of life, a user can use one avatar that is used in association with the user's interest in hiking, and another avatar that is used in association with the user's college alma mater.

Depending on the implementation, a user can first created one or more avatars, and add them to the dynamic avatar provisioning system 108 (e.g., via the dynamic avatar engine) for future use in connection with one or more social-based web resources. For example, a user can create one or more avatars that represent their personality or what aspect of their personality that the user wants to project/publish with the avatar through their online user profile. The avatar could be something that the user does for work, play or charity, or what defines the user. With respect to the professional world, the user can create and add an avatar relating to their role as a marketing professional, a java developer, an entrepreneur, or the like. With respect to the personal world, the user can create and add an avatar relating to the user being (or once being) a Harvard alumnus, a football-player, a chess-player, a golfer, or the like. With respect to the social world, the user can create and add an avatar relating to the user being (or once being) a volunteer, a fund-raiser, a donor, a social worker, a sponsor, or the like.

Subsequently, a user can associate a particular avatar for use with a particular social-based web resource, a particular user dimension, or both. In doing so, a user can specify which avatar they want to project through the user's online profile on a particular social-based web resource and in association with a particular user dimension (e.g., in connection with interest group, an event or activity). A given social-based web resource can have one or more avatars associated with it, and each avatar can relate to a particular aspect of the user's online profile on the given social-based web resource.

For various implementations, user dimensions can include one or more intent that the particular avatar is expected to derive for a user. Examples of intents can include job hunting, networking, finding users, selling goods, buying goods, dating, traveling, and the like. A user can create one or more intents to describe what they are looking for/seeking through a social-based web resource. Generally, a user intent can include, but is not limited to, an activity (e.g., hiring individuals, getting hired, recruiting, networking, or learning) and search request (e.g., for a person, place, thing, or event). For example, user intent can relate to a search for specific kinds of people the user is interested in targeting, or can relate to search for specific kinds of events that the user would be interested in attending. The later example of a user intent can be automatically generated by the dynamic avatar provisioning system 108 based on the interests the user has or the kind of people the user is intending to target.

Individual and businesses typically have one or more intents at any point of time, and the intents can be static or dynamically changing. Some intents change dynamically over time or with change of context and/or location. For some implementations, a user can have the ability to create their own intent or set of intents and manage them.

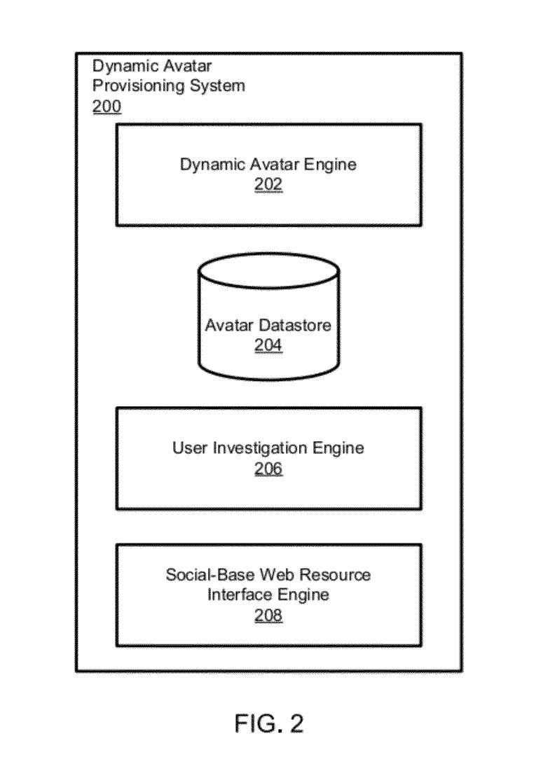

FIG. 2 depicts an example of a dynamic social avatar provisioning system 200 in accordance with various implementations. The dynamic social avatar provisioning system 200 can be implemented, for example, in exemplary environment 100 presented in FIG. 1, as dynamic social avatar provisioning system 108. In the example of FIG. 2, the dynamic social avatar provisioning system 200 includes a dynamic avatar engine 202, an avatar datastore 204, a user investigation engine 206, and a social-base web resource interface engine 208.

The dynamic avatar engine 202 is intended to represent the components used to manage a set of avatars on behalf of a user, to manage association between avatars in the set and the user's various online profiles on the social-based web resources, and to provision avatars for use with the user's various online profiles according to aspects of the user's online profile (e.g., according to the user dimensions included in the user's online profile). In some implementations, the dynamic avatar engine 202 is coupled to the avatar datastore 204 and configured to: manage a set of avatars associated with a user and stored on the avatar datastore, manage an association between at least one avatar in the set of avatars and a first interest or a first intent associated with the user, and dynamically provide the at least one avatar (from the set of avatars) to a particular web resource for use with an online profile associated with the user, where the online profile is accessible through the particular web resource and the online profile includes a second interest relating to the first interest or a second intent relating to the first intent. For various implementations, the commonality between the first and second interests/intents ensures that the dynamic avatar engine 202 provides the particular web resource with an avatar that can not only be used with (e.g., presented in) the user's online profile, but can also be used appropriately in the user's online profile, in connection with the second interest/intent, according to the user's selections/settings.

The dynamic avatar engine 202 can, for example, associate an avatar (for use in an online user profile) according to a user interest, a user intent, the social-based web resource (that is requesting and intends to use the dynamically provided avatar), the intended viewer/audience of the avatar (e.g., a fellow user having sharing a common interest), or some combination therefore. The dynamic avatar engine 202 can provide a social-based web resource an avatar for use in response to a request made by a social-based web resource requests use of an avatar. Application programming interfaces (APIs), native to either the dynamic avatar provisioning system 200, the social-based web resource, or both, can be employed to facilitate requests for avatars (in connection with a user and the user's online profile), to facilitate transmission of an avatar from the dynamic avatar provisioning system 200 to the social-based web resource for use, and to facilitate usage of the supplied avatar in association with an online user profile. Use of APIs can enable certain implementation of the dynamic avatar provisioning system 200 to better integrate with social-based web resources.

Which avatar is provisioned by the dynamic avatar engine 202 can vary according to the avatar request received by the dynamic avatar engine 202 from a social-based web resource intending to use the avatar. In its request, a social-based web resource can specify several parameters that can determine the avatar to be supplied by the dynamic avatar engine 202, including, without limitation, identification of the social-based web resource making the request, identification of the user to be represented by the avatar, and the context in which the avatar is intended be used (e.g., presented) in connection with the user's online profile. Depending on the implementation, avatars provisioned by the dynamic avatar engine 202 can be considered to be a “context-based avatar” or a “dynamically-provided avatar” utilized in connection with an online user profile.

The avatar datastore 204 is intended to represent the components used to store the set of avatars managed and provisioned, and can include the association between the avatars and online user profiles. The user investigation engine 206 can configured to access and gather information regarding a particular user from a social-based web resource. The information gathered by the user investigation engine 206 can include, for example, user interests, user intent, user connectivity (e.g., with other users or with interests groups), social postings, and social activities. The information gathered by the user investigation engine 206 can constitute the dimensions of a particular user, which are utilized by the dynamic avatar engine 202 in associating aspects of the particular user's online profile with specific avatars.

The social-based web resource interface engine 208 is intended to represent the components used to provide the dynamic avatar provisioning system 200, and its various components) access to a social-based web resource, and a user's online user profile. For example, the social-based web resource interface engine 208 can employed by the user investigation engine 206 to access a social-based web resource, and by the dynamic avatar engine 202 to provision (e.g., provide) an avatar to one or more of social-based web resources for use with an online user profile (e.g., in connection with a particular user dimension included in the online user profile).

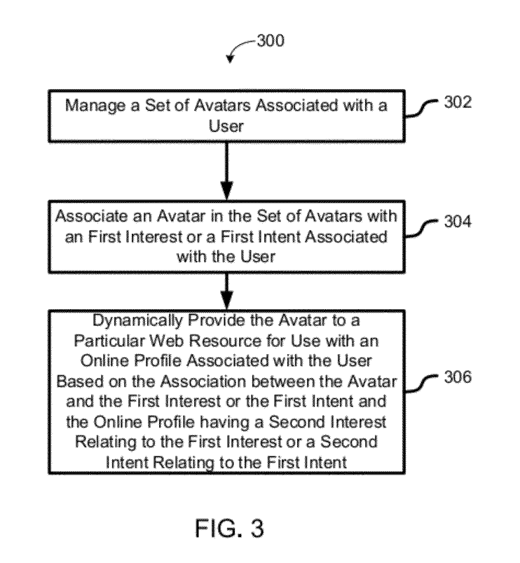

FIG. 3 depicts a flowchart 300 of an example of a method for dynamically provisioning social avatar in accordance with various implementations. The flowchart 300, and other flowcharts in this paper, are illustrated as serially arranged modules and decision points, but can be reordered or arranged for parallel execution of certain modules.

In the example of FIG. 3, the flowchart 300 starts at module 302 with managing a set of avatars associated with a user. Management of the set of avatars can include, for example, creating or uploading avatars to an implementation, adding avatars to the set of avatars the user can use, and removing avatars from the set of avatars the user can use.

In the example of FIG. 3, the flowchart 300 continues to module 304 with associating one or more avatars in the set of avatars with a first interest or a first intent associated with the user. For some implementations, the first interest or the first intent can be those created or specified by the user through the implementation and/or interests or intents imported from one or more of the user's online profiles (on various social-based web resources). In addition to interests and intent, the user can associate an avatar with any of a number of other user dimensions created, specified, or imported in by the user including, such as, social activities performed by the user, roles the user fills in their life (e.g., with respect to work, volunteering, or hobbies), or social connections the user can have.

In the example of FIG. 3, the flowchart 300 continues to module 306 with dynamically providing one or more avatars to a particular web resource (e.g., social-based web resource) for use with an online profile associated with the user. The module 306 can dynamically provide the one or more avatars based on an association between the avatar and first user dimension (e.g., first interest or first intent) created, specified, or imported in by the module 304. The online user profile with which the avatars are intended to be used can have an associated second user dimension (e.g., second interest or second intent) that relates to the first user dimension. This (weak or strong) correspondence between the dimensions ensures that certain implementations provide an appropriate, user-selected avatar for the given context of use (with the user's online profile).

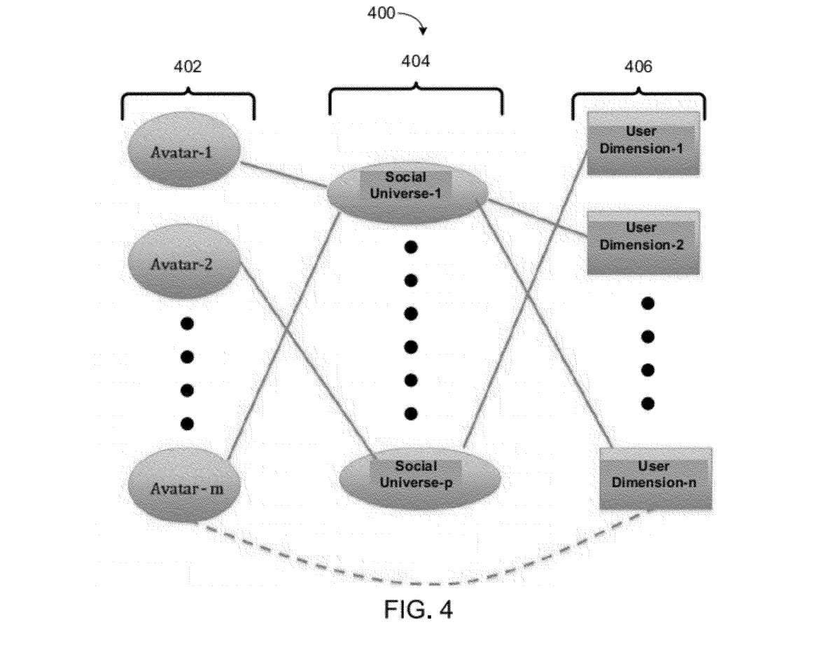

FIG. 4 depicts a flowchart 400 illustrating an example of correlations/associations between avatars, social universes, and user dimensions, in accordance with various implementations. The social universes are intended to represent a context of use for an avatar in association with one or more of the user's online profiles. As such, a user can associate one or more avatars 402 with one or more universes 404, as illustrated in FIG. 4. Through associations with social universes, the user can choose to exhibit one avatar to fellow users that are family members on Google+®, another to fellow users that are college alumni on LinkedIn®, another to indicate to fellow users in the user's football league on Facebook® that he or she is a ‘Football player,’ and another to indicate to fellow users that are charity friends on Facebook® that he or she is a ‘Treasurer.’ In some implementations, one of the social universes 404 to which the user chooses to exhibit/attach one or more avatars can be a geophysical event, a virtual event, a geo-physical or virtual group, a club, an organization, a campaign, or a variation thereof.

As noted above, the avatars 402 can belong to one or more social universes 404. An event, group, campaign, network are just some examples of social universe. According to various implementations, the avatars 402 can be auto-created and exhibited to different groups of a user's friends or connections to the social universes 404. In some instances, one of the social universes 404 can include one or more social-based web resources, which define part of the context of use. The context of use of each of the social universes 404 can be further defined by association with one or more user dimensions 406, which further narrow/limit the context of use associated with a given social universe. Accordingly, one of the social universes 404 can be associated with an organization, club, or group a user is part of, or can be associated with an event or campaign.

For some implementations, a user can have one or more user dimensions 406 associated with one or more of the avatars 402, and can have one or more use dimensions 406 associated with one or more social universes 404. Various implementations can provide totally independence between associations, allowing a user to dynamically attach one or more avatars 402 and/or one or more user dimensions 406 to any of the social universes 404. In particular implementations, management of the avatars 402 (e.g., creation and removal) can be automatically facilitated based on a user's changing online profile (e.g., social network profile), activities, or any other information the implementations discover regarding the user. Management of the user dimensions 406 can be automatically facilitated in a similar manner.

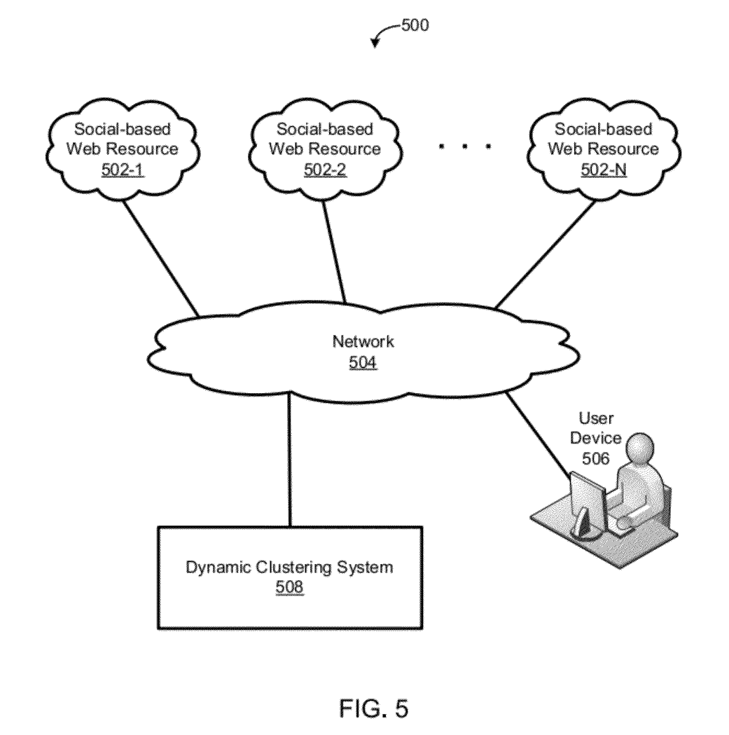

FIG. 5 depicts an example of a dynamic clustering system 508, in use in an exemplary environment 500, in accordance with various implementations. In the example of FIG. 5, the exemplary environment 500 includes a network 504, one or more social-based web resources 502-1 to 502-N (hereafter referred to collectively as the social-based web resources 502), a user device 506, and the dynamic clustering system 508. The dynamic clustering system 508 can be one configured to dynamically group users, dynamically group social (e.g., user) connections, or send conference/convention notifications to potentially interested users in accordance with various implementations.

In the example of FIG. 5, the network 504 is intended to include an applicable communications network such as the Internet, a public switched telephone network (PSTN), an infrastructure network (e.g., private LAN), or some other network that is capable of acting as a link between the various components depicted in FIG. 5. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). A PSTN can include wired or wireless (e.g., 4G/3G/2G) network operated by, for example, a central provider. An infrastructure network that offers wireless connectivity can include wired and wireless devices in communication with wireless access points (WAPs).

In the example of FIG. 5, the social-based web sources 502 are coupled to the network 502. The social-based web sources 502 can include known or convenient social networks, such as Facebook®, LinkedIn® or Google+®, and other online social services (e.g., social news and social media postings), such as Twitter®, Reddit®, Digg®, Pinterest®. The social-based web sources 502 can comprise social structures operative to connect individuals, persons, or entities, by levels of interdependency. Thus, any or all of the social-based web sources 502 can connect members based on friendship, familial relationships, financial relationships, business relationships, ideological relationships or other relationships (e.g., interests or intents).

In the example of FIG. 5, the user device 506 is coupled to the network 504. The network 504 can include a local network and an intermediate network, where the user device 506 can be coupled to the intermediate network 502 through a local wireless network. At a minimum, a user device 506 can include a processor, memory (though the memory could be implemented in the processor), a radio, and a radio interface (though the radio interface could be implemented as “part of” the radio). In order to make the user device 506 will typically have at least one input device and at least one output device, including input and output interfaces, if applicable. A user device can include components of a computer system 1200, as shown in FIG. 12.

In the example of FIG. 5, the user device 506 can be as a phone, personal data assistant (PDA), computing device, laptop, net book, tablet, camera, music/media player, GPS device, networked appliance, or some other known or convenient user device; and/or various types of intermediate networking devices. The user device 506 can or cannot be a wireless device, but the description often refers to the user device as a wireless device because it is a likely implementation in at least a subset of user cases. Through the user device 506, a user can access one or more of the social-based web resources 502 (e.g., social network or social news) and search for other users, user postings, communicate with other users, and make connections with other users. Additionally, the user can search for other users having common dimensions (e.g., interests, activities, hobbies, and discussion).

In the example of FIG. 5, the dynamic clustering system 508 can include a user discovery engine, a data mining engine, a clustering engine, a reverse-clustering engine, a user management engine, and a cluster management engine in accordance with some implementations. Depending on the implementation, some or all of the components can be utilized in performing dynamic user grouping, dynamic social connection grouping, or targeted conference/convention notification. The user discovery engine can be configured to discover users or user connections on the social-based web resources 502, possibly based on search/discovery criteria (e.g., association with a particular user dimension, or based on user connection). The data mining engine can be configured to obtain and extract information relating to a user (e.g., user connection information, user dimensions, etc.) from the social-based web resources 502. The information gathered can be later utilized for clustering purposes. The clustering engine can be configured to perform clustering algorithms that can generate various dynamic clusters of users or connections that belong in a given cluster. The reverse-clustering engine can be configured to attract the users matching particular criteria towards a user-defined grouping of users or connections. The user management engine can be configured to manage for each user what user groups or user connections groups are presently relevant to the user (e.g., based on user dimensions) and what groups they should be auto-added to or auto-deleted from. The cluster management engine can be configured to manage the overall clusters/groups of users or user connections created by various implementations, as well as deletes or archives any vestigial clusters created by various implementations.

With respect to using the dynamic clustering system 508 for dynamic user grouping, various implementations can create a dynamic group of users having one or more specific user dimensions, including topics, activities, interests, or social discussions. Various implementations can dynamically group users by determining what user dimensions users presently have. For example, users in a dynamic group can automatically remain in a group as long as they are actively interested in the dynamic groups' topic. Certain implementations can determine a user's interest in a dynamic group's associated user dimension(s) by determining users participation and activity level of the user with regard to the user dimension(s) (e.g., by monitoring or mining for the user's social feeds and postings). The inactive users in a dynamic group can be auto-deleted when their activity level in the group's topic falls below a particular threshold (e.g., which can be set by the group's creator). For some implementations, users newly active in a particular topic associated with a dynamic group can be discovered and auto-added to the dynamic group. In doing so, dynamic groups can evolve according to participation and activity.

Through use of various implementations, users can be dynamically clustered based on one or more user dimensions (e.g., interests, activities, skills, time, event, geography, or age), users can be automatically added to dynamic groups, users can be automatically removed from dynamic groups when users are no longer relevant to the group or active in the group, and dynamic groups can be removed when no users remain in the group (e.g., because current users are no longer active and no new users are interested in the dynamic group's associated user dimension(s)).

With respect to using the dynamic clustering system 508 for dynamic connection grouping, various implementations can create a dynamic group of a user's connections according to user dimensions (e.g., a specific geography or are interested in a specific area/topic/activity/interest/discussion). Groups for connections are selected and clustered based on one or more user dimensions. For some implementations, the clusters are dynamic and connections can stay in a group as long as a user is actively interested or active in the user dimensions of that connection group. Certain implementations can determine a user's interest in a connection group's associated user dimension(s) by determining user participation and activity level of the user with regard to the user dimension(s) (e.g., by monitoring or mining for the user's social feeds and postings). Accordingly, the connections can be auto-classified, where newly active connections are auto-added to relevant clusters and auto-deleted from others which are no longer relevant to them. The clusters evolve with user participation and involvement. For instance, if a given user connection moves from the San Francisco to Boston, he or she can be auto-deleted from the San Francisco cluster and added to the Boston cluster of user connections.

Through use of various implementations, user connections can be dynamically clustered based on one or more user dimensions (e.g., interests, activities, skills, time, event, geography, or age), user connections can be automatically added to dynamic groups, user connections can be automatically removed from dynamic groups when user connections are no longer relevant to the group, and dynamic groups can be removed when no user connections remain in the group (e.g., because current user connections have moved and no new user connections are interested in the dynamic group's associated user dimension(s)).

Irrespective of whether it is employed in dynamically grouping users, dynamically grouping user connections, or both), the dynamic clustering system 508 can be beneficial in at least some of the following exemplary use cases: for social group networking by individual users or corporations; for merchants/vendors/corporations to discover and add customers or potential customers to their groups; for merchants/vendors to connect with current and potential customers to obtain product feedback, increase sales, increase customers, or increase customer loyalty; for leveraging user networks for targeted uses by users in the social and the professional context; and for marketers to use the data and target marketing efforts to target customers who would be interested in their products (e.g., marketers can create a targeted group and have people auto-clustered under those, using the reverse-clustering engine).

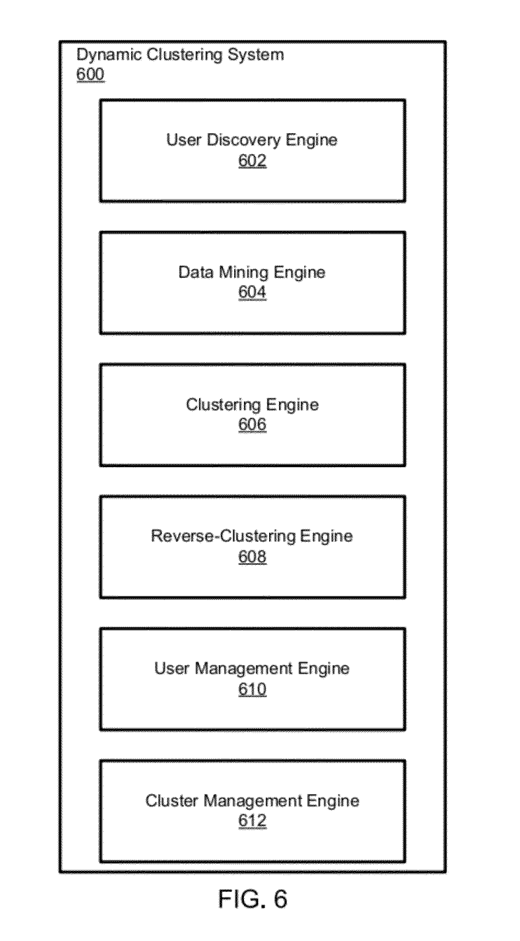

FIG. 6 depicts an example of a dynamic clustering system 600 in accordance with various implementations. The dynamic clustering system 600 can be implemented, for instance, in exemplary environment 500 presented in FIG. 5, as the dynamic clustering system 508. In the example of FIG. 6, the dynamic clustering system 600 includes a user discovery engine 602, a data mining engine 604, a clustering engine 606, a reverse-clustering engine 608, user management engine 610, and a cluster management engine 612. Depending on the implementation, some or all of the components can be utilized in performing dynamic user grouping, dynamic social connection grouping, or targeted conference/convention notification. The user discovery engine 602 can be configured to discover users on the social-based web resources, possibly based on search/discovery criteria (e.g., association with a particular user dimension, or based on user connection). The data mining engine 604 can be configured to obtain and extract information relating to a user (e.g., connection information, user dimensions, etc.) from the social-based web resources. The information gathered can be utilized by clustering algorithms. The clustering engine 606 can be configured to perform clustering algorithms that can generate various dynamic clusters of users or connections that belong in a given cluster. The reverse-clustering engine 608 can be configured to attract the users matching particular criteria towards a user-defined grouping of users or connections. The user management engine 610 can be configured to manage for each user what groups are presently relevant to the user (e.g., based on user dimensions) and what groups they should be auto-added to or auto-deleted from. The cluster management engine 612 can be configured to manage the overall clusters/groups created by various implementations, as well as deletes or archives any vestigial clusters created by various implementations.

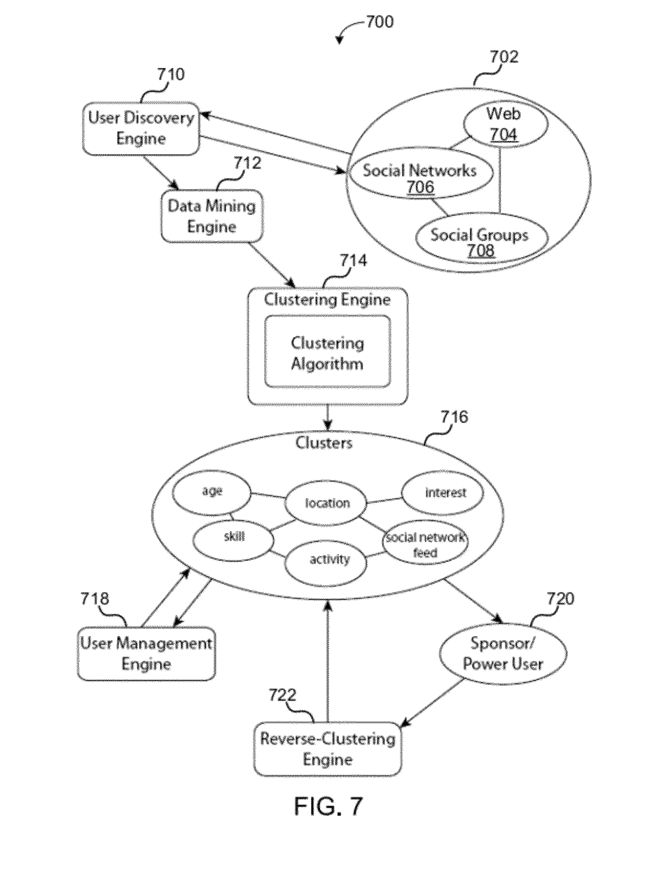

FIG. 7 depicts a conceptual diagram an example of dynamic clustering system for user grouping in accordance with various implementations. FIG. 7 depicts social-based web resources (e.g., web 704, social networks 706, social groups 708) a user discovery engine 710, a data mining engine 712, a clustering engine 714, generated clusters 716 (e.g., age, geographic location, skill, activity, social network feed, interests), a user management engine 718, a reverse-clustering engine 722, and a sponsor/power user interface 720.

The user discovery engine 710 can discover users or user connections within the social-based web resources 702. Based on those users or user connections, the data mining engine 714 obtain and extract useful user data relating to the users or user connections, which can later be analyzed by the clustering engine 714 for clustering purposes. The clustering engine 714 can perform various clustering algorithms on the information gathered by the data mining engine 714, and can generate clusters 716 (e.g., user clusters/groups or user connection clusters/groups) based as a result. The clusters 716 can be generated according to various user dimensions, include age, skill, geographic location, activities, social network feed content, or interests. Based on the clusters 716, the user management engine 718 can manage (for each user) what user groups or user connection groups are presently relevant to a user and what groups they should be auto-added to or auto-deleted from. The reverse-clustering engine 722 can attract the users matching particular criteria towards a user-defined cluster 716 of users or connections. The sponsor/power-user interface 720 can provide a user the ability to define group/cluster criteria, which can into the reverse-clustering engine 722.

Although not depicted in FIG. 7, the group/cluster management engine can be configured to manage the overall clusters 716 of users or user connections created by various implementations, as well as deletes any vestigial clusters created by various implementations.

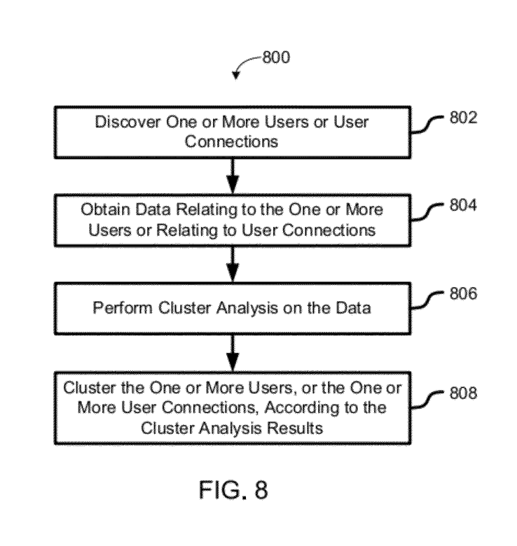

FIG. 8 depicts a flowchart 800 of an example of a method for dynamically clustering in accordance with various implementations. As with the other flowcharts in this paper, the flowchart 800 is illustrated as serially arranged modules and decision points, but it should be appreciated that the flowchart 800 could be reordered or arranged for parallel execution of certain modules.

In the example of FIG. 8, the flowchart 800 starts at module 802 with discovering one or more users or user connections, preferably within one or more social-based web resources. In some implementations, the discovery of user can be facilitated through a user discovery engine configured to access the social-based web resources and access online user profiles.

In the example of FIG. 8, the flowchart 800 continues to module 804 with obtaining data relating to the users or user connections. For some implementation, the obtaining of data can be performed by a data mining engine configured to access online user profiles and crawl through information provided via the online user profiles.

In the example of FIG. 8, the flowchart 800 continues to module 806 with performing cluster analysis on the data collected. In certain implementations, the cluster analysis can be performed by a cluster engine configured to apply cluster algorithms on the collected data.

In the example of FIG. 8, the flowchart 800 continues to module 808 with clustering the one or more users or the one or more user connections according to the results from the cluster analysis. The generation of clusters can also be performed by the clustering engine.

According to some implementations, the method in accordance with FIG. 8 can comprise: acquiring user data from social-based web resources (e.g., social networks, existing social groups, or the web); running clustering algorithms on the user data (e.g., structured or unstructured, unsupervised learning); and dynamically creating the dynamic group of user or user connections based on the users or user connections that get clustered under the dynamic groups associated criteria. The criteria associated with a dynamic group can be determined naturally by the users or user connections clustered together, or by clustering criteria inputted (e.g., by a sponsor or super user) for reverse-clustering purposes; these determine the given criteria for a dynamic group of users or user connections.

As noted herein, the clustering algorithms can be performed on multiple dimensions including, but not limited, to age, location, interest, skill, activity, social network feeds, social network posts, blogs written by the user, and other content created by the user. It is possible for a given user or user connection to belong to one or more clusters at the same time and, as a result, also belong to one or more dynamic groups associated with those clusters. Generally, users or user connections clustered together and then added to a dynamic group. However, in some implementations, a dynamic group of users or user connections can be dynamically generated by sponsors or power users defining target group criteria, and a reverse-clustering engine acting on the target group criteria (e.g., discovering and clustering users or user connections that fall within the target group criteria).

Subsequently, when one or more users or user connections in a dynamic group become inactive or change in their associated user dimensions (e.g., interests/location/age), the dynamic group can become irrelevant with respect to the users or user connections; such users and user connections can be auto-deleted from the dynamic group, thereby maintaining active users and user connections. On the other hand, when new users or new user connections matching the user dimensions of a particular dynamic group are discovered, they can be clustered and automatically added to a given dynamic group. The various implementations permit various social-based web resources (e.g., social networks) to automatically or manually create and maintain dynamic user groups or dynamic user connection groups that are organic, living, and substantially self-sustaining.

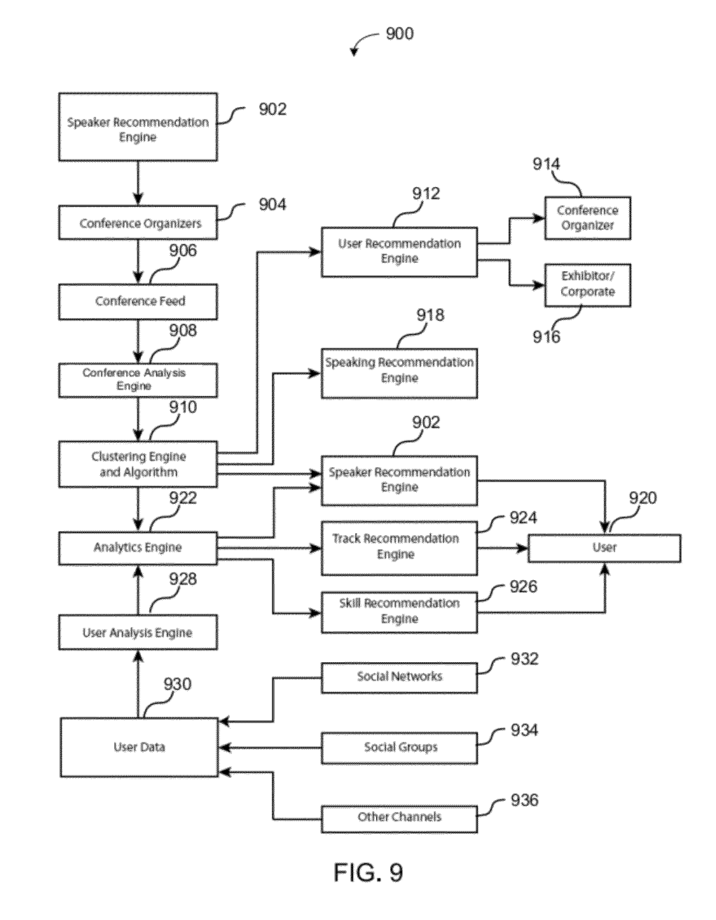

FIG. 9 depicts a flowchart 900 illustrating an example of a dynamic clustering system for conference/convention notifications in accordance with various implementations. The dynamic clustering system of FIG. 9 can be implemented, in some implementations, in exemplary environment 500 presented in FIG. 5, as the dynamic clustering system 508. In the example of FIG. 9, the dynamic clustering system includes a speaker recommendation engine 902, a conference analysis engine 908, a clustering engine 910, a user recommendation engine 912, a speaking recommendation engine 918, an analytics engine 922, a track recommendation engine 924, a skill recommendation engine 926, and a user analysis engine 928. The dynamic clustering system of FIG. 9 can interact/interface with human actors, such as conference organizers 904 and a user 920.

Data sources for information regarding conferences and conventions (hereafter collectively referred to as “conferences”) may include, without limitation, a conference feed 906 (e.g., web based feed) that is maintained by the conference organizers 904. The conference analysis engine 908 can analyze data provided by the conference feed 906 (and possibly other conference information data sources, such as the web sites Eventbrite, Meetup, and Plancast), while the and the clustering engine 910 can cluster conferences according to analysis data provided by the conference analysis engine 908. The analysis data produced by the conference analysis engine 908 can include, without limitation, dimensions relating to the conferences (hereafter referred to as “conference dimensions”), such as areas, geography, and skills developed. The conference clustering engine 910 can create clusters of conferences using various conference attributes. The user analysis engine 928 can create clusters of users based on user dimensions (such as skills, profession, title, interests, and expertise) and the analytics engine 928 can match different clusters of conferences to appropriate clusters of users. The resulting matches can be provided to the speaker recommendation engine 902, the track recommendation engine 924, and the skill recommendation engine 926 so that clusters of conferences can be recommended to the appropriate clusters of users.

The analytics engine 928 can also match the appropriate clusters of users to the appropriate exhibitors at a conference. In doing so, exhibitors can target the most appropriate and relevant audience at a conference (or even outside a conference) and engage them. This can result in a high conversion ratio and a high ROI for exhibitors and the conference organizers alike.

The user analysis engine 928 can process user data 930 provided by way of social networks 932, social groups 934, and other possible channels 936. The user data 930 can include, without limitation, information from a user's online profile (e.g., on a social-based web resource, such as a social network site) or a user's online resume. The user data can also be obtained from sources such as blogs, RSS feeds, and corporate profiles.

By analyzing the user data 930, the user analysis engine 928 can identify one or more areas the user may, for example, be currently interested in, identify one or more skills the user may already have, or identify one or more skills the user may be interested in developing.

The speaking recommendation engine 918 can identify and recommend conferences the user 920 can possibly speak at (or may be interested at speaking at). The speaking recommendation engine 918 can, for some implementations, base its identification and recommendation process on the user's experiences, such as the user's resume, the user's professional online profile, or both.

The speaker recommendation engine 902 can identify and recommend potential speakers the user 920 should follow, track or attend sessions for. The speaker recommendation engine 902 can, for some implementations, base its identification and recommendation process on the user's experiences, such as the user's resume, the user's professional online profile, or both. In some implementations, the speaker recommendation engine 902 can also analyze a database of conferences and recommend speakers to the conference organizers 904 for a particular conference. The speaker recommendations to the conference organizers can be based on speaker profile analysis, speaker experience and speaker skill in the areas relevant to the particular conference.

The track recommendation engine 924 can recommend to the user 920 various potential sessions or tracks the user may benefit from, based on analyzing the user's skills, interests or new roles. Although the track recommendation engine 924 can base its recommendations on the user existing skills and skills he or she is interested in developing, the track recommendation engine 924 can also recommend session or tracks to the user 920 based on user data of other users who used to have a similar skill set as that of the user 920, and the new skills other users are acquiring and benefiting from. Accordingly, the track recommendation engine 924 can possibly extrapolate what the user 920 could benefit from learning or acquiring based on the data of other users.

The skill recommendation engine 926 can recommend what other skills the user 920 may benefit from based on the skills he or she has and the skills he or she could benefit from learning. The skill recommendation engine 926 can also present the user 920 with trends of what other users who has his or her intersecting skills are acquiring in terms of new and additional skills.

Various implementations can be configured to mine a user's information, identify the most relevant conferences for the user, and notify him or her of upcoming conferences and registration deadlines. Implementations can also recommend to a user specific sessions within a conference that would be useful for the user to advance his or her career. Some implementations can enable a user to allocate a budget in advance of a conference and/or setup auto-registration for important conferences as soon as they open up (thereby allowing users to register for such popular and sold out conferences such as Apple®'s WWDC & Google® I/O.

With some implementations, an end user can be an individual professional wishing to attend conferences relevant to his or her career, and wishing to register for them before the registration deadline, at times before the early-bird period expires. Additionally, an end user can also be conference organizers wishing to market their conferences to the relevant users who would benefit from attending the conference and/or would be interested in attending the conference. A conference organizer could potentially sell individual sessions or conference tracks to those users who cannot afford the time or money to attend the whole conference, but may be interested in only a few select conference tracks or sessions.

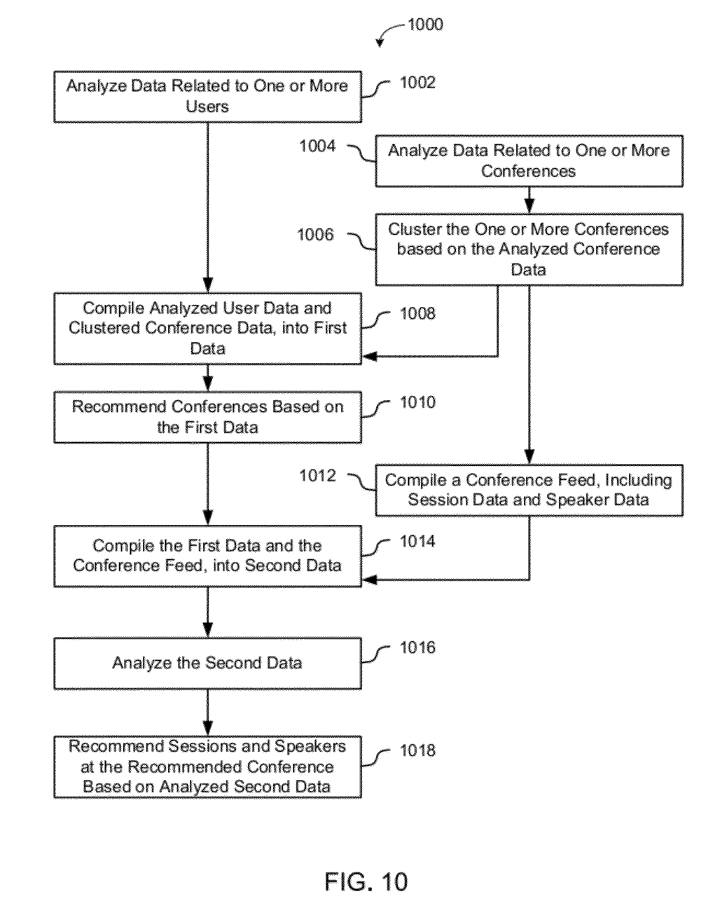

FIG. 10 depicts a flowchart 1000 of an example of a method for conference/convention notifications in accordance with various implementations. As with the other flowcharts in this paper, the flowchart 1000 is illustrated as serially arranged modules and decision points, but it should be appreciated that the flowchart 1000 could be reordered or arranged for parallel execution of certain modules.

In the example of FIG. 10, the flowchart 1000 starts module 1002, which analyzing data related to one or more users. Depending on the implementation, the user data can include such sources as social-based web resources (e.g., social networks), blogs, or RSS feeds.

In the example of FIG. 10, the flowchart 1000 also starts module 1004, which analyzed data related to one or more conferences. Data regarding conferences can include, for example, a conference feed maintained by conference organizers, or such web sites as Eventbrite, Meetup, and Plancast.

In the example of FIG. 10, the flowchart 1000 continues from the module 1004 to module 1006 with clustering the one or more conferences based on the analyzed data from the module 1004. The clustering of conferences can be performed by a clustering engine.

In the example of FIG. 10, the flowchart 1000 continues from the module 1006 to module 1008 with compiling analyzed user data with clustered conference data from the module 1006, to result in first data. Subsequently, the flowchart 1000 continues to module 1010 with recommending conferences (e.g., to a user) based on the first data compiled by the module 1008.

In the example of FIG. 10, the flowchart 1000 also continues from the module 1006 to module 1012 with compiling a conference feed from the clustered conference data produced by the module 1006. The conference feed can include session data, speaker data, and possibly other data regarding the clustered conferences.

In the example of FIG. 10, the flowchart 1000 continues to module 1014 with compiling the first data from the module 1010 with the conference feed compiled by the module 1012, to produce second data.

In the example of FIG. 10, the flowchart 1000 continues to module 1016 with analyzing the second data, and then to module 1018 with recommending session and speakers at the recommended based on the analyzed second data.

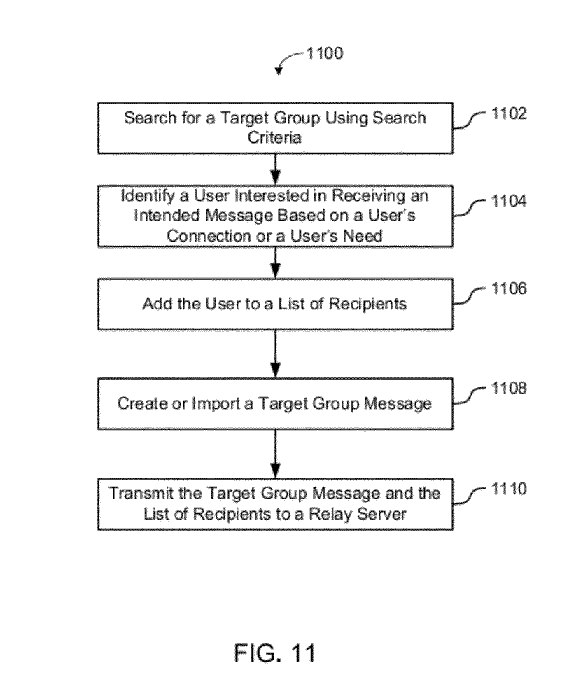

FIG. 11 depicts a flowchart 1100 of an example of a method for target group messaging in accordance with various implementations. As with the other flowcharts in this paper, the flowchart 1100 is illustrated as serially arranged modules and decision points, but it should be appreciated that the flowchart 1100 could be reordered or arranged for parallel execution of certain modules.

In the example of FIG. 11, the flowchart 1100 starts at module 1102 with searching for target groups using search criteria. The search criteria can be specified by a sending user, who intends to send a target group message to one or more interested, recipient users. Various implementations facilitate the search process by searching for a target group of (recipient) users in a given database (e.g., fellow users on a social-based web resource that are connected with the sending user), context (e.g., fellow users on a social-based web resource who share a particular interest), or area (e.g., fellow users on a social-based web resource within a specific geographic proximity to the sending user). The target group of users ultimately identified can depending on either search criteria specified or search criteria intelligently and dynamically selected by an implementation.

In the example of FIG. 11, the flowchart 1100 continues to module 1104 with identifying one or more users interested in receiving an intended message based on a user's connection or user's need. For some implementations, the module 1104 can dynamically identify the one or more users can involve applying machine learning algorithms on the user's connections or the user's needs according to information gathered from a user's online profile on a social-based web resource (e.g., social networking site). The machine learning algorithms can help determine, from the user's connections and needs, what group of recipient users the sending user might be interested in transmitting the intended message to. Eventually, the flowchart 1100 continues to module 1106 with adding the one or more users identified in module 1104 to the list of recipients.

In the example of FIG. 11, the flowchart 1100 continues to module 1108 with creating or importing a target group message intended to be sent to the list of recipients. In the module 408, the sending user can create a new message from scratch, or can have a message imported in from another service or application.

In the example of FIG. 11, the flowchart 1100 continues to module 1110 with transmitting the target group message and the list of recipients to a relay server. Ultimately, the relay server receives the target group message and the list of recipients and sends the target group message to the list of recipients. For some implementations, the relay server can be configured to join the list of recipients to a multicast group, and send a multicast message to only to the list of recipients.

According to some implementations, the method illustrated in FIG. 11 can facilitate mass selection of a group of recipients to send a targeted group message. Various implementations can facilitate this by intelligently identifying a targeted group of people (e.g., based on user data), and sending a targeted group message to the targeted group of people via a relay server. Some implementations can be useful and find use in the following scenarios: • (a) where exhibitors at a conference wish to sending messages to a select group of people they are targeting to attract to their booths; (b) where friends looking for each other at a crowded event and wanting to broadcast to a select group of friends present at the event; (c) where corporations wish to send a message to their potential customers; (d) where recruiters wish to send a job description only to individual who match the job description/profile; and (e) where marketeers/distributors wish to send a targeted group message to their clients or potential clients.

FIG. 12 depicts an example of a computer system 1200 on which techniques described in this paper can be implemented. The computer system 1200 can be a conventional computer system that can be used as a client computer system, such as a wireless client or a workstation, or a server computer system. The computer system 1200 includes a computer 1202, I/O devices 1204, and a display device 1206. The computer 1202 includes a processor 1208, a communications interface 1210, memory 1212, display controller 1214, non-volatile storage 1216, and I/O controller 1218. The computer 1202 can be coupled to or include the I/O devices 1204 and display device 1206.

The computer 1202 interfaces to external systems through the communications interface 1210, which can include a modem or network interface. It will be appreciated that the communications interface 1210 can be considered to be part of the computer system 1200 or a part of the computer 1202. The communications interface 1210 can be an analog modem, ISDN modem, cable modem, token ring interface, satellite transmission interface (e.g. “direct PC”), or other interfaces for coupling a computer system to other computer systems.

The processor 1208 can be, for example, a conventional microprocessor such as an Intel Pentium microprocessor or Motorola power PC microprocessor. The memory 1212 is coupled to the processor 1208 by a bus 1270. The memory 1212 can be Dynamic Random Access Memory (DRAM) and can also include Static RAM (SRAM). The bus 1270 couples the processor 1208 to the memory 1212, also to the non-volatile storage 1216, to the display controller 1214, and to the I/O controller 1218.

The I/O devices 1204 can include a keyboard, disk drives, printers, a scanner, and other input and output devices, including a mouse or other pointing device. The display controller 1214 can control in the conventional manner a display on the display device 1206, which can be, for example, a cathode ray tube (CRT) or liquid crystal display (LCD). The display controller 1214 and the I/O controller 1218 can be implemented with conventional well known technology.

The non-volatile storage 1216 is often a magnetic hard disk, an optical disk, or another form of storage for large amounts of data. Some of this data is often written, by a direct memory access process, into memory 1212 during execution of software in the computer 1202. One of skill in the art will immediately recognize that the terms “machine-readable medium” or “computer-readable medium” includes any type of storage device that is accessible by the processor 1208 and also encompasses a carrier wave that encodes a data signal.

The computer system 1200 is one example of many possible computer systems which have different architectures. For example, personal computers based on an Intel microprocessor often have multiple buses, one of which can be an I/O bus for the peripherals and one that directly connects the processor 1208 and the memory 1212 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1212 for execution by the processor 1208. A Web TV system, which is known in the art, is also considered to be a computer system, but it can lack some of the features shown in FIG. 12, such as certain input or output devices. A typical computer system will usually include at least a processor, memory, and a bus coupling the memory to the processor.

In addition, the computer system 1200 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 1216 and causes the processor 1208 to execute the various acts required by the operating system to input and output data and to store data in memory, including storing files on the non-volatile storage 1216.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus can be specially constructed for the required purposes, or it can comprise a general purpose computer selectively activated or reconfigured by a computer program stored in the computer. Such a computer program can be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems can be used with programs in accordance with the teachings herein, or it can prove convenient to construct more specialized apparatus to perform the required method steps. The required structure for a variety of these systems will appear from the description below. In addition, the present invention is not described with reference to any particular programming language, and various embodiments can thus be implemented using a variety of programming languages.

Although the foregoing embodiments have been described in some detail for purposes of clarity of understanding, the invention is not limited to the details provided. There are many alternative ways of implementing the invention. The disclosed embodiments are illustrative and not restrictive.

We claim:

1. A system comprising:
an avatar datastore;
a dynamic avatar engine coupled to the avatar datastore and configured to:
manage a set of avatars associated with a user and stored on the avatar datastore,
manage an association between at least one avatar in the set of avatars and a first interest or a first intent associated with the user, and
dynamically provide the at least one avatar in the set of avatars to a particular web resource for use with an online profile associated with the user, wherein the online profile is accessible through the particular web resource and the online profile includes a second interest relating to the first interest or a second intent relating to the first intent.

2. The system of claim 1, wherein the at least one avatar is to be used with the online profile in a context associated with the second interest or the second intent.

3. The system of claim 1, wherein the dynamic avatar engine dynamically provides the at least one avatar, from the set of avatars to a particular web resource, for use with the online profile by:
receiving a request, from the particular web resource, for an avatar relating to a second interest or a second intent associated with the online profile;
identifying the at least one avatar in the set of avatars based on the second interest or the second intent; and
providing to the particular web resource the at least one avatar for use with the online profile.

4. The system of claim 1, wherein the dynamic avatar engine is further configured to:
determine the second interest or the second intent from a context through which the online profile is being accessed.

5. The system of claim 1, wherein the particular web resource is selected from a group consisting of a social networking website and an online forum.

6. The system of claim 1, wherein using the at least one avatar comprises presenting the at least one avatar is conjunction with the online profile.

7. The system of claim 1, wherein the avatar datastore further stores the association between the at least one avatar and the first interest or the first intent.

8. The system of claim 1, comprising a user investigation engine configured to determine the first interest or the first intent associated with the user from user information that is associated with the user and provided by a web resource.

9. The system of claim 8, wherein the user information is a social network profile and the web resource is a social networking website.

10. The system of claim 8, wherein the user investigation engine is further configured to monitor the user information for a change and re-determine the first interest or the first intent based on the change.

11. The system of claim 1, wherein the first intent relates to an activity the user wishes to perform.

12. The system of claim 1, wherein the first intent relates to an object the user is seeking.

13. The system of claim 1, further comprising a web resource interface engine configured to access the particular web resource.

14. The system of claim 1, wherein managing the set of avatars associated with the user comprises adding a new avatar to the set of avatars or removing an existing avatar from the set of avatars.

15. The system of claim 1, wherein the dynamic avatar engine is further configured to automatically manage the set of avatars according to a change to the first interest or the first intent.

16. A method comprising:
managing a set of avatars associated with a user;
associating at least one avatar in the set of avatars with a first interest or a first intent associated with the user;
dynamically providing the at least one avatar in the set of avatars to a particular web resource for use with an online profile associated with the user, wherein the online profile is accessible through the particular web resource and the online profile includes a second interest relating to the first interest or a second intent relating to the first intent.

17. The method of claim 16, wherein the at least one avatar is to be used with the online profile in a context associated with the second interest or the second intent.

18. The method of claim 16, wherein dynamically providing the at least one avatar, from the set of avatars to a particular web resource, for use with the online profile by:
receiving a request, from the particular web resource, for an avatar relating to a second interest or a second intent associated with the online profile;
identifying the at least one avatar in the set of avatars based on the second interest or the second intent;
providing to the particular web resource the at least one avatar for use with the online profile.

19. The method of claim 16, further comprising determining the second interest or the second intent from a context through which the online profile is being accessed.

20. The method of claim 16, wherein the particular web resource is selected from a group consisting of a social networking website and an online forum.

21. The method of claim 16, wherein using the at least one avatar with the online profile comprises presenting the at least one avatar is conjunction with the online profile.

22. The method of claim 16, further comprising determining the first interest or the first intent associated with the user from user information that is associated with the user and provided by a web resource.

23. The method of claim 22, further comprising:
monitoring the user information for a change;
re-determining the first interest or the first intent based on the change.

24. The method of claim 16, wherein the first intent relates to an activity the user wishes to perform.

25. The method of claim 16, wherein the first intent relates to an object the user is seeking.

26. The method of claim 16, further comprising accessing the particular web resource.

27. The method of claim 16, wherein managing the set of avatars associated with the user comprises adding a new avatar to the set of avatars or removing an existing avatar from the set of avatars.

28. The method of claim 16, further comprising automatically managing the set of avatars according to a change to the first interest or the first intent.

29. A system comprising:
a means for managing a set of avatars associated with a user;
a means for associating at least one avatar in the set of avatars with a first interest or a first intent associated with the user;
a means for dynamically providing the at least one avatar in the set of avatars to a particular web resource for use with an online profile associated with the user, wherein the online profile is accessible through the particular web resource and the online profile includes a second interest relating to the first interest or a second intent relating to the first intent.
